(19) United States
(12) Patent Application Publication
(10) Pub. No.: US 2025/0160380 A1
(43) Pub. Date: May 22, 2025

(54) NUTRITIONAL COMPOSITION FOR GASTROINTESTINAL ENVIRONMENT TO PROVIDE IMPROVED MICROBIOME AND METABOLIC PROFILE

(71) Applicant: Mead Johnson Nutrition Company, Evansville, IN (US)

(72) Inventors: Maciej Witalis Chichlowski, Roseville, CA (US); Brian BERG, Evansville, IN (US)

(73) Assignee: Mead Johnson Nutrition Company, Evansville, IN (US)

(21) Appl. No.: 19/027,195

(22) Filed: Jan. 17, 2025

Related U.S. Application Data
(63) Continuation of application No. 17/718,520, filed on Apr. 12, 2022.
Application No. 17/718,520 is a continuation of application No. 14/503,555, filed on Oct. 1, 2014, now abandoned.

(51) Int. Cl. A23L 33/10; A23L 33/00; A23L 33/115; A23L 33/12; A23L 33/135; A23L 33/17; A23L 33/175; A23L 33/21; A23L 33/26

(52) U.S. Cl. CPC A23L 33/10; A23L 33/115; A23L 33/12; A23L 33/135; A23L 33/17; A23L 33/175; A23L 33/21; A23L 33/26; A23L 33/40; A23V 2002/00; A23V 2400/175

(57) ABSTRACT

The present disclosure involves a method and nutritional composition for improving the microbiome and metabolic profile of a pediatric subject, which includes administering to a pediatric subject a composition having up to about 7 g/100 kCal of a protein or protein equivalent source; up to about 7 g/100 kCal of a fat or lipid source; at least about 5 g/100 kCal of a carbohydrate; at least about 0.05 mg/100 kCal of bacterial metabolites; and either a probiotic or a prebiotic composition, or both.

### CROSS REFERENCE TO RELATED APPLICATIONS/INCORPORATION BY REFERENCE STATEMENT

The subject application is a continuation of U.S. Ser. No. 17/718,520, filed Apr. 12, 2022; which is a continuation of U.S. Ser. No. 14/503,555, filed Oct. 1, 2014. The entire contents of the above-referenced patent application(s) are hereby expressly incorporated herein by reference.

### TECHNICAL FIELD

The present disclosure relates generally to nutritional composition for producing a gastrointestinal (GI) environment to provide an improved microbiome and metabolic profile in a pediatric subject. The nutritional composition includes bacterial metabolites in combination with a probiotic, such as Lactobacillus rhamnosus GG (LGG), and/or a prebiotic composition. The nutritional composition is suitable for administration to pediatric subjects. Additionally, the disclosure provides methods for producing an improved GI environment in order to provide optimized microbiome and metabolic profile. The nutritional composition(s) provided herein comprise a combination that can provide additive and or/synergistic beneficial health effects.

### BACKGROUND ART

There is emerging evidence to suggest the gut microbiota has the ability to communicate with the brain and therefore affect behavior and brain development and functions. This microbiome-gut-brain-axis concept in health and disease has been demonstrated through preclinical and clinical observations. Gut microbiota interacts with enteric and central nervous systems via neural, neuroendocrine, neuroimmune and hormonal links. In addition, therapeutic use of antibiotics can cause abnormal development by skewing the microbiome, possibly altering the homeostatic mechanisms or leading to expansion of pathogen reservoir.

As such, what is needed are methods and compositions for improving gut microbiota composition and activity such that pediatric subjects will experience beneficial effects on brain development and function and which promote overall health of an infant or child. Benefits of such methods and compositions may include:
1. Support normal brain and/or mental development
2. Support cognitive development, including sensorimotor development, exploration and manipulation, object relatedness, object recognition
3. Support social-emotional development
4. Support better sleep
5. Decrease stress, reduce crying, colic and fussiness
6. Improve resilience to stress conditions.

As such, provided herein are methods and compositions of improving the gut microbiota in a target subject, by providing a nutritional composition that includes a combination of bacterial metabolites with at least one probiotic and/or a prebiotic composition, to the target subject.

### DETAILED DESCRIPTION

Briefly, the present disclosure is directed, in an embodiment, to a method for improving the GI environment of a pediatric subject by providing a nutritional composition that contains i) a carbohydrate source, ii) a protein source, iii) a fat source, iv) bacterial metabolites, and v) at least one probiotic and/or a prebiotic composition. In some embodiments, the probiotic is LGG. In other embodiments, the nutritional compositions disclosed herein include the combination of bacterial metabolites, LGG and a prebiotic composition comprising galacto-oligosaccharides (GOS) and polydextrose (PDX) in an infant formula.

In certain embodiments the nutritional composition(s) may optionally contain a source of long chain polyunsaturated fatty acids (“LCPUFAs”), β-glucan, lactoferrin, a source of iron, and mixtures of one or more thereof. Exemplary suitable LCPUFAs include docosahexaenoic acid (“DHA”) and arachidonic acid (“ARA”),

Additionally, the disclosure is directed to a method of improving gut microbiota composition and/or function by providing to a pediatric subject a nutritional composition having a combination of bacterial metabolites with a probiotic and/or a prebiotic composition. Further provided is a method for improving the microbiome and metabolic profile of a pediatric subject by providing a nutritional composition having a combination of bacterial metabolites with a probiotic and/or a prebiotic composition.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

The present disclosure relates generally to methods of improving gut microbiota composition and/or function by providing to a pediatric subject a nutritional composition having a combination of bacterial metabolites with a probiotic and/or a prebiotic composition. Further, the disclosure relates to a method for improving the microbiome and metabolic profile of a pediatric subject by providing a nutritional composition having a combination of bacterial metabolites with a probiotic and/or a prebiotic composition.

“Nutritional composition” means a substance or formulation that satisfies at least a portion of a subject's nutrient requirements. The terms “nutritional(s)”, “nutritional formula(s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults.

“Pediatric subject” means a human less than 13 years of age. In some embodiments, a pediatric subject refers to a human subject that is between birth and 8 years old. In other embodiments, a pediatric subject refers to a human subject between 1 and 6 years of age. In still further embodiments, a pediatric subject refers to a human subject between 6 and 12 years of age. The term “pediatric subject” may refer to infants (preterm or fullterm) and/or children, as described below.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, and preterm infants. “Preterm” means an infant born before the end of the 37^{th} week of gestation. “Full term” means an infant born after the end of the 37^{th} week of gestation.

“Child” means a subject ranging in age from 12 months to about 13 years. In some embodiments, a child is a subject between the ages of 1 and 12 years old. In other embodiments, the terms “children” or “child” refer to subjects that are between one and about six years old, or between about seven and about 12 years old. In other embodiments, the terms “children” or “child” refer to any range of ages between 12 months and about 13 years.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant. In certain embodiments, the disclosed nutritional composition is nutritionally complete for a full term infant.

Likewise, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant. In certain embodiments, the disclosed nutritional composition is nutritionally complete for a preterm infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child. In certain embodiments, the disclosed nutritional composition is nutritionally complete for a child.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

“Bacterial metabolites” refers to an array of chemicals synthesized by microbes to regulate their own growth and development, to encourage other organisms beneficial to them, and to suppress organisms that are harmful. Generally, though not exclusively, bacterial metabolites are relatively small molecular weight (i.e. <2500 amu) compounds.

The term “degree of hydrolysis” refers to the extent to which peptide bonds are broken by a hydrolysis method. For example, the protein source of the present disclosure may, in some embodiments comprise hydrolyzed protein having a degree of hydrolysis of no greater than 40%. For this example, this means that no more than 40% of the total peptide bonds have been cleaved by a hydrolysis method. The degree of protein hydrolysis for purposes of characterizing the hydrolyzed protein component of the nutritional composition is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

The term “partially hydrolyzed” means having a degree of hydrolysis which is greater than 0% but less than 50%.

The term “extensively hydrolyzed” means having a degree of hydrolysis which is greater than or equal to 50%.

“Probiotic” means a microorganism with low or no pathogenicity that exerts at least one beneficial effect on the health of the host. An example of a probiotic is LGG.

In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such source is now known or later developed.

The term “inactivated probiotic” means a probiotic wherein the metabolic activity or reproductive ability of the referenced probiotic organism has been reduced or destroyed. The “inactivated probiotic” does, however, still retain, at the cellular level, at least a portion its biological glycol-protein and DNA/RNA structure. As used herein, the term “inactivated” is synonymous with “non-viable”. More specifically, a non-limiting example of an inactivated probiotic is inactivated Lactobacillus rhamnosus GG (“LGG”) or “inactivated LGG”.

The term “cell equivalent” refers to the level of non-viable, non-replicating probiotics equivalent to an equal number of viable cells. The term “non-replicating” is to be understood as the amount of non-replicating microorganisms obtained from the same amount of replicating bacteria (cfu/g), including inactivated probiotics, fragments of DNA, cell wall or cytoplasmic compounds. In other words, the quantity of non-living, non-replicating organisms is expressed in terms of cfu as if all the microorganisms were alive, regardless whether they are dead, non- replicating, inactivated, fragmented etc.

“Prebiotic” means a non-digestible food ingredient that beneficially affects the host by selectively stimulating the growth and/or activity of one or a limited number of bacteria in the digestive tract that can improve the health of the host. Examples of prebiotics include PDX and GOS.

“β-glucan” means all β-glucan, including specific types of β-glucan, such as β-1,3-glucan or β-1,3;1,6-glucan. Moreover, β-1,3;1,6-glucan is a type of β-1,3-glucan. Therefore, the term “β-1,3-glucan” includes β-1,3;1,6-glucan.

As used herein, “non-human lactoferrin” means lactoferrin which is produced by or obtained from a source other than human breast milk. In some embodiments, non-human lactoferrin is lactoferrin that has an amino acid sequence that is different than the amino acid sequence of human lactoferrin. In other embodiments, non-human lactoferrin for use in the present disclosure includes human lactoferrin produced by a genetically modified organism. The term “organism,” as used herein, refers to any contiguous living system, such as animal, plant, fungus or micro-organism.

“Inherent lutein” or “lutein from endogenous sources” refers to any lutein present in the formulas that is not added as such, but is present in other components or ingredients of the formulas; the lutein is naturally present in such other components.

All percentages, parts and ratios as used herein are by weight of the total composition, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified as the endpoint(s) of any range. Any reference to a range should be considered as providing support for any subset within that range.

The present disclosure is directed to a method of improving gut microbiota composition and/or function, and for improving the microbiome and metabolic profile of a pediatric subject, by providing a nutritional composition having a combination of bacterial metabolites with a probiotic and/or a prebiotic composition.

Potential mechanisms of action by which the nutritional composition disclosed herein could affect the healthy gut environment and affect brain and behavior include bacterial metabolites gaining access to the brain and/or affecting gut-brain axis; stimulation of the afferent neural pathways, including the vagus nerve or sympathetic neurotransmitters to promote healthy brain development; modulation of pathways and genes involved in cognition; and support of the healthy, normal or improved behavioral, psychomotor and emotional development of the pediatric subject.

Accordingly, as provided herein, the specific combination of bacterial metabolites with probiotic and/or prebiotic material, in combination, may optimize the composition of gastrointestinal microbiota and support development of the gut-brain axis in pediatric subjects, including infants and children.

A major pathway for interactions between the gut microbes and a host, such as a pediatric subject, occur through the exchange of metabolites. Bacterial metabolites encompass a group of molecules which may be found in circulation, and that are a product of bacterial metabolism. Thus, the present nutritional composition may, in certain embodiments, provide important bacterial metabolites, at a level of about 0.5 mg/100 kcal to about 1 g/100 kcal, more particularly from about 50 mg/100 kcal to about 500 mg/100 kcal. Included among the bacterial metabolites are one or more of: a) short chain fatty acids (SCFA), b) bile acids, c) polyphenols, d) amino acids, e) neurotransmitters and f) signaling factors.

In one embodiment, the disclosed nutritional composition can include any one or more of three primary SCFAs produced by microbiota fermentation: acetate and propionate, that can be absorbed into portal circulation, and butyrate which can be used as an energy source for colonocytes by the host. SCFA are also signaling molecules and can have neuroactive properties. SCFA can also stimulate neurogenesis. Significantly, SCFA can act via complementary mechanisms, i.e. butyrate acts via CAMP dependent mechanisms, while propionate acts via gut-brain neural circuit involving the fatty acid receptor FFAR3. Propionate is an agonist of FFAR3 in the periportal afferent neural system. When incorporated in the nutritional composition, SCFAs are present at a level of about 0.5 mg/100 kcal to about 1 g/100 kcal. In other embodiments, SCFAs are present at a level of about 50 mg/100 kcal to about 500 mg/100 kcal.

In certain embodiments, the bacterial metabolites included in the disclosed composition may provide bile acids which can further mediate communication of the microbiota with the pediatric subject. The primary bile acids are produced by the liver, and are dehydroxylated by bacteria from the genus Lactobacillus, Bifidobacterium, Clostridium and Bacteroides. These two types of microbial derived metabolites may affect the metabolism of different organs. Other bile acids that are produced by the bacteria and might have implication on the health of the host are: 6-beta-hydroxylithocholate, hyocholate, glycohyocholate, hyodeoxycholate, taurohyodeoxycholic acid and glycohyodeoxycholic acid. Bile acids are present in the disclosed nutritional composition at a level of about 0.5 mg/100 kcal to about 1 g/100 kcal, in some embodiments. In other embodiments, bile acids are present at a level of about 50 mg/100 kcal to about 500 mg/100 kcal.

The disclosed nutritional composition may, in some embodiments, include the polyphenol equol, which is an isoflavan metabolite; equol can affect the behavior via gut-brain axis mechanism. Various bacteria are involved in production of equol, including Adlercreutzia equolfaciens. Another polyphenol that can, in other embodiments, be incorporated in the nutritional composition is 3,4-Dihydroxyphenyl acetic acid (DOPAC). DOPAC is produced by various bacteria including Bacteroides sp., Lactobacillus sp. and Bifidobacterium sp. It has potentially neuroprotective effects, for example protection of neuronal cells against oxidative stress and apoptosis in neuronal cells. Another polyphenol produced by bacteria that might be included in some embodiments is 5-(3′,4′-Dihydroxyphenyl)-y-valerolactone and has anti-inflammatory and antioxidant effect. In embodiments when one or more polyphenols are among the bacterial metabolites included in the nutritional composition, they are included at a level of about 0.5 mg/100 kcal to about 1 g/100 kcal; on other embodiments, the polyphenols are included at a level of about 50 mg/100 kcal to about 500 mg/100 kcal.

The nutritional composition of the present disclosure may also contain neurometabolites that are either neurotransmitters or modulators of neurotransmission, including gamma-aminobutyric acid (GABA) produced by Lactobacillus spp. and Bifidobacterium sp.; noradrenaline produced by Escherichia sp., Bacillus spp. and Saccharomyces sp.; serotonin from Candida sp., Streptococcus sp., Escherichia sp. and Enterococcus spp.; dopamine from Bacillus spp.; and acetylcholine from Lactobacillus sp. These neurometabolites directly act on central nervous system via nerve terminals in the gut and have an effect on behavior and brain development, and, in embodiments, are present at a level of about 0.5 mg/100 kcal to about 1 g/kcal. In other embodiments, neurometabolites are present at a level of about 50 mg/100 kcal to about 500 mg/100 kcal.

The disclosed bacterial metabolites for inclusion herein can, in certain embodiments, comprise soluble factors secreted by probiotics such as LGG which influence epithelial permeability, inhibit inflammatory cascades, or promote maturation and activation of dendritic cells. For example, two soluble factors produced by LGG (p75 and p40) activate the Akt protein via phosphatidylinositol-3′-kinase-dependent mechanism and prevent cytokine-mediated apoptosis thus promoting intestinal homeostasis. Soluble factors from LGG also play a role in the regulation of nutrient metabolism. In addition, low-molecular weight peptides (i.e., peptides having a molecular weight of less than 5 kiloDaltons (kDa)) secreted from LGG induce expression of cytoprotective heat shock proteins (Hsp 25 and 27) and activate a number of MAP kinases in murine intestinal cells. Thus, LGG-produced Hsp may provide a protective effect against oxidative damage. Soluble factors, when present, are at a level of about 0.05 mg/100 kcal to about 250 mg/100 kcal; in some embodiments, the soluble facts are present at 50 mg/100 kcal to about 100 mg/100 kcal.

Other bacterial metabolites which are, in some embodiments, incorporated in the nutritional composition of the present disclosure include: indoleacetate, metabolized by Azoarcus evansii, 5-amino valerate and phenyllactate. In embodiments when any of the foregoing metabolites of this paragraph, or combinations thereof, are included in the nutritional composition, they are present at a total level of about 0.5 mg/100 kcal to about 500 mg/100 kcal.

Still other bacterial metabolites which are suitable in some embodiments of the disclosure are: homovanillate, N,N-dimethylglycine, hippurate and benzoate.

Homovanillate is the breakdown product of dopamine. N/N-dimethylglycine is a building block for proteins and neurotransmitters; it is a derivative of the amino acid glycine. The production of hippurate requires both microbial and mammalian metabolism. Benzoate is a salt of benzoic acid. When one or more of the metabolites of the present paragraph are present in the nutritional composition of the disclosure, they are present at a total level of about 0.5 mg/100 kcal to about 500 mg/100 kcal.

The nutritional composition of the present disclosure also includes a probiotic, a prebiotic composition, or both.

In some embodiments, the probiotic of the nutritional composition comprises Lactobacillus rhamnosus GG (ATCC number 53103). In other embodiments, the disclosed nutritional composition(s) described herein may comprise a probiotic other than LGG, either in addition to LGG or in place of LGG. Additional probiotics that may be included in the nutritional composition include, but are not limited to: Bifidobacterium species, Bifidobacterium longum BB536 (BL999, ATCC: BAA-999), Bifidobacterium longum AH1206 (NCIMB: 41382), Bifidobacterium breve AH1205 (NCIMB: 41387), Bifidobacterium infantis 35624 (NCIMB: 41003), and Bifidobacterium animalis subsp. lactis BB-12 (DSM No. 10140) or any combination thereof.

In some embodiments, the nutritional composition includes a probiotic such as LGG in an amount of from about 1×10⁴ cfu/100 kcal to about 1.5×10¹⁰ cfu/100 kcal. In other embodiments, the nutritional composition comprises a probiotic in an amount of from about 1×10⁶ cfu/100 kcal to about 1×10⁹ cfu/100 kcal. Still, in certain embodiments, the nutritional composition may include a probiotic in an amount of from about 1×10⁷ cfu/100 kcal to about 1×10⁸ cfu/100 kcal.

In some embodiments, the probiotic of the nutritional composition includes a culture supernatant from a late-exponential growth phase of a probiotic batch-cultivation process, as disclosed in international published application no. WO 2013/142403, which is hereby incorporated by reference in its entirety. Without wishing to be bound by theory, it is believed that the activity of the culture supernatant can be attributed to the mixture of components (including proteinaceous materials, and possibly including (exo) polysaccharide materials) as found released into the culture medium at a late stage of the exponential (or “log”) phase of batch cultivation of the probiotic. The term “culture supernatant” as used herein, includes the mixture of components found in the culture medium. The stages recognized in batch cultivation of bacteria are known to the skilled person. These are the “lag,” the “log” (“logarithmic” or “exponential”), the “stationary” and the “death” (or “logarithmic decline”) phases. In all phases during which live bacteria are present, the bacteria metabolize nutrients from the media, and secrete (exert, release) materials into the culture medium. The composition of the secreted material at a given point in time of the growth stages is not generally predictable.

In an embodiment, a culture supernatant is obtainable by a process comprising the steps of (a) subjecting a probiotic such as LGG to cultivation in a suitable culture medium using a batch process; (b) harvesting the culture supernatant at a late exponential growth phase of the cultivation step, which phase is defined with reference to the second half of the time between the lag phase and the stationary phase of the batch-cultivation process; (c) optionally removing low molecular weight constituents from the supernatant so as to retain molecular weight constituents above 5-6 kDa; (d) removing liquid contents from the culture supernatant so as to obtain the composition.

The culture supernatant may comprise secreted materials that are harvested from a late exponential phase. The late exponential phase occurs in time after the mid exponential phase (which is halftime of the duration of the exponential phase, hence the reference to the late exponential phase as being the second half of the time between the lag phase and the stationary phase). In particular, the term “late exponential phase” is used herein with reference to the latter quarter portion of the time between the lag phase and the stationary phase of the LGG batch-cultivation process. In some embodiments, the culture supernatant is harvested at a point in time of 75% to 85% of the duration of the exponential phase, and may be harvested at about ⅚ of the time elapsed in the exponential phase.

In some embodiments, the nutritional composition comprises the culture supernatant from about 0.015 mg/100 kcal to about 1.5 mg/100 kcal.

The disclosed nutritional composition can, in some embodiments, comprise a prebiotic composition. Prebiotics exert health benefits, which may include, but are not limited to, selective stimulation of the growth and/or activity of one or a limited number of beneficial gut bacteria, stimulation of the growth and/or activity of ingested probiotic microorganisms, selective reduction in gut pathogens, and favorable influence on gut short chain fatty acid profile. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide and gentio-oligosaccharides. Other suitable prebiotics include 2′-fucosyllactose (2FL), 31-fucosyllactose (3FL), S′-sialyllactose (3SL), 6′-sialyllactose (6SL), lacto-N-biose (LNB), lacto-N-neotetraose (LnNT) and/or lacto-N-tetraose (LNT).

In an embodiment, the total amount of prebiotics present in the nutritional composition may be from about 1.0 g/L to about 10.0 g/L of the composition. In a particular (but non-limiting) embodiment, the total amount of prebiotics present in the nutritional composition may be from about 2.0 g/L and about 8.0 g/L of the composition.

In certain embodiments, the prebiotic composition comprises GOS or, in some embodiments, GOS in combination with PDX. In some embodiments, the amount of GOS in the nutritional composition may be from about 0.015 mg/100 kcal to about 1.5 mg/100 kcal. In another embodiment, the amount of GOS in the nutritional composition may be from about 0.1 mg/100 kcal to about 0.5 mg/100 kcal.

The amount of PDX in the nutritional composition may, in some embodiments, be within the range of from about 0.1 mg/100 kcal to about 0.5 mg/100 kcal. In other embodiments, the amount of PDX may be about 0.3 mg/100 kcal. In a particular embodiment, GOS and PDX are supplemented into the nutritional composition in a total amount of about at least about 0.2 mg/100 kcal and can be about 0.2 mg/100 kcal to about 1.5 mg/100 kcal. In some embodiments, the nutritional composition may comprise GOS and PDX in a total amount of from about 0.6 to about 0.8 mg/100 kcal.

In one embodiment, where the nutritional composition is an infant formula, the combination of bacterial metabolites, along with a probiotic and/or a prebiotic composition, may be added to a commercially available infant formula. For example, Enfalac, Enfamil®, Enfamil® Premature Formula, Enfamil® with Iron, Enfamil® LIPIL®, Lactofree®, Nutramigen®, Pregestimil®, and ProSobee® (available from Mead Johnson & Company, Evansville, IN, U.S.A.) may be supplemented with bacterial metabolites, along with a probiotic and/or a prebiotic composition, and used in practice of the current disclosure.

The nutritional composition(s) of the present disclosure may also comprise a carbohydrate source. Carbohydrate sources can be any used in the art, e.g., lactose, glucose, fructose, corn syrup solids, maltodextrins, sucrose, starch, rice syrup solids, and the like. The amount of carbohydrate in the nutritional composition typically can vary from between about 5 g and about 25 g/100 kcal. In some embodiments, the amount of carbohydrate is between about 6 g and about 22 g/100 kcal. In other embodiments, the amount of carbohydrate is between about 12 g and about 14 g/100 kcal. In some embodiments, corn syrup solids are desired. Moreover, hydrolyzed, partially hydrolyzed, and/or extensively hydrolyzed carbohydrates may be desirable for inclusion in the nutritional composition due to their easy digestibility. Specifically, hydrolyzed carbohydrates are less likely to contain allergenic epitopes.

Non-limiting examples of carbohydrate materials suitable for use herein include hydrolyzed or intact, naturally or chemically modified, starches sourced from corn, tapioca, rice or potato, in waxy or non-waxy forms. Non-limiting examples of suitable carbohydrates include various hydrolyzed starches characterized as hydrolyzed cornstarch, maltodextrin, maltose, corn syrup, dextrose, corn syrup solids, glucose, and various other glucose polymers and combinations thereof. Non-limiting examples of other suitable carbohydrates include those often referred to as sucrose, lactose, fructose, high fructose corn syrup, indigestible oligosaccharides such as fructooligosaccharides and combinations thereof.

The nutritional composition(s) of the disclosure may also comprise a protein or protein equivalent source. The protein source can be any used in the art, e.g., nonfat milk, whey protein, casein, soy protein, hydrolyzed protein, amino acids, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In some embodiments, the proteins of the nutritional composition are provided as intact proteins. In other embodiments, the proteins are provided as a combination of both intact proteins and hydrolyzed proteins. In certain embodiments, the proteins may be partially hydrolyzed or extensively hydrolyzed. In still other embodiments, the protein source comprises amino acids. In yet another embodiment, the protein source may be supplemented with glutamine-containing peptides. In another embodiment, the protein component comprises extensively hydrolyzed protein. In still another embodiment, the protein component of the nutritional composition consists essentially of extensively hydrolyzed protein in order to minimize the occurrence of food allergy. In yet another embodiment, the protein source may be supplemented with glutamine-containing peptides.

In a particular embodiment of the nutritional composition, the whey: casein ratio of the protein source is similar to that found in human breast milk. In an embodiment, the protein source comprises from about 40% to about 90% whey protein and from about 10% to about 60% casein.

Some people exhibit allergies or sensitivities to intact proteins, i.e. whole proteins, such as those in intact cow's milk protein or intact soy protein isolate-based formulas. Many of these people with protein allergies or sensitivities are able to tolerate hydrolyzed protein. Hydrolysate formulas (also referred to as semi-elemental formulas) contain protein that has been hydrolyzed or broken down into short peptide fragments and/or amino acids and as a result is more easily digested. In people with protein sensitivities or allergies, immune system associated allergies or sensitivities often result in cutaneous, respiratory or gastrointestinal symptoms such as vomiting and diarrhea. People who exhibit reactions to intact protein formulas often will not react to hydrolyzed protein formulas because their immune system does not recognize the hydrolyzed protein as the intact protein that causes their symptoms.

Some gliadins and bovine caseins may share epitopes recognized by anti-gliadin IgA antibodies. Accordingly, then, in some embodiments, the nutritional composition of the present disclosure reduces the incidence of food allergy, such as, for example, protein allergies and, consequently, the immune reaction of some patients to proteins such as bovine casein, by providing a protein component comprising hydrolyzed proteins, such as hydrolyzed whey protein and/or hydrolyzed casein protein. A hydrolyzed protein component contains fewer allergenic epitopes than an intact protein component.

Accordingly, in some embodiments, the protein component of the nutritional composition comprises either partially or extensively hydrolyzed protein, such as protein from cow's milk. The hydrolyzed proteins may be treated with enzymes to break down some or most of the proteins that cause adverse symptoms with the goal of reducing allergic reactions, intolerance, and sensitization. Moreover, the proteins may be hydrolyzed by any method known in the art.

When a peptide bond in a protein is broken by enzymatic hydrolysis, one amino group is released for each peptide bond broken, causing an increase in amino nitrogen. It should be noted that even non-hydrolyzed protein would contain some exposed amino groups. Hydrolyzed proteins will also have a different molecular weight distribution than the non-hydrolyzed proteins from which they were formed. The functional and nutritional properties of hydrolyzed proteins can be affected by the different size peptides. A molecular weight profile is usually given by listing the percent by weight of particular ranges of molecular weight fractions (e.g., 2-5 kDa, greater than 5 kDa, etc.).

As previously mentioned, persons who exhibit sensitivity to whole or intact proteins can benefit from consumption of nutritional formulas containing hydrolyzed proteins. Such sensitive persons may especially benefit from the consumption of a hypoallergenic formula.

In some embodiments, the nutritional composition of the present disclosure is substantially free of intact proteins. In this context, the term “substantially free” means that the embodiments herein comprise sufficiently low concentrations of intact protein to thus render the formula hypoallergenic. The extent to which a nutritional composition in accordance with the disclosure is substantially free of intact proteins, and therefore hypoallergenic, is determined by the August 2000 Policy Statement of the American Academy of Pediatrics in which a hypoallergenic formula is defined as one which in appropriate clinical studies demonstrates that it does not provoke reactions in 90% of infants or children with confirmed cow's milk allergy with 95% confidence when given in prospective randomized, double-blind, placebo-controlled trials.

Another alternative for pediatric subjects, such as infants, that have food allergy and/or milk protein allergies is a protein-free nutritional composition based upon amino acids. Amino acids are the basic structural building units of protein. Breaking the proteins down to their basic chemical structure by completely pre-digesting the proteins makes amino acid-based formulas the most hypoallergenic formulas available.

In a particular embodiment, the nutritional composition is protein-free and contains free amino acids as a protein equivalent source. In this embodiment, the amino acids may comprise, but are not limited to, histidine, isoleucine, leucine, lysine, methionine, cysteine, phenylalanine, tyrosine, threonine, tryptophan, valine, alanine, arginine, asparagine, aspartic acid, glutamic acid, glutamine, glycine, proline, serine, carnitine, taurine and mixtures thereof. In some embodiments, the amino acids may be branched chain amino acids. In other embodiments, small amino acid peptides may be included as the protein component of the nutritional composition. Such small amino acid peptides may be naturally occurring or synthesized. In an embodiment, 100% of the free amino acids have a molecular weight of less than 500 Daltons. In this embodiment, the nutritional formulation may be hypoallergenic.

In some embodiments, the nutritional composition comprises between about 1 g and about 7 g of a protein or protein equivalent source per 100 kcal. In other embodiments, the nutritional composition comprises between about 3.5 g and about 4.5 g of protein per 100 kcal.

In some embodiments, the nutritional composition described herein comprises a fat source. Appropriate fat sources include, but are not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

In some embodiments, the nutritional composition comprises between about 1 g and about 10 g of a fat source per 100 kcal. In other embodiments, the nutritional composition comprises between about 3.5 g and about 7 g of a fat source per 100 kcal.

In some embodiments the nutritional composition may also include a source of LCPUFAs. In one embodiment the amount of LCPUFA in the nutritional composition is advantageously at least about 5 mg/100 kcal, and may vary from about 5 mg/100 kcal to about 100 mg/100 kcal, such as (but not limited to) from about 10 mg/100 kcal to about 50 mg/100 kcal. Non-limiting examples of LCPUFAs include, but are not limited to, DHA, ARA, linoleic (18:2 n-6), γ-linolenic (18:3 n-6), dihomo-γ-linolenic (20:3 n-6) acids in the n-6 pathway, α-linolenic (18:3 n-3), stearidonic (18:4 n-3), eicosatetraenoic (20:4 n-3), eicosapentaenoic (20:5 n-3), and docosapentaenoic (22:6 n-3).

In some embodiments, the LCPUFA included in the nutritional composition may comprise DHA. In one embodiment the amount of DHA in the nutritional composition is from about 15 mg/100 kcal to about 75 mg/100 kcal. Still in some embodiments, the amount of DHA in the nutritional composition is from about 10 mg/100 kcal to about 50 mg/100 kcal.

In another embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The DHA and ARA can be in natural form, provided that the remainder of the LCPUFA source does not result in any substantial deleterious effect on the infant. Alternatively, the DHA and ARA can be used in refined form.

The disclosed nutritional composition described herein can, in some embodiments, also comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000;120:413-431.)

β-1,3-glucans are naturally occurring polysaccharides, with or without β-1,6-glucose side chains that are found in the cell walls of a variety of plants, yeasts, fungi and bacteria. β-1,3;1,6-glucans are those containing glucose units with (1,3) links having side chains attached at the (1,6) position(s). β-1,3;1,6 glucans are a heterogeneous group of glucose polymers that share structural commonalities, including a backbone of straight chain glucose units linked by a β-1,3 bond with β-1,6-linked glucose branches extending from this backbone. While this is the basic structure for the presently described class of β-glucans, some variations may exist. For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

In some embodiments, the β-glucan is β-1,3;1,6-glucan. In some embodiments, the β-1,3;1,6-glucan is derived from baker's yeast. The nutritional composition may comprise whole glucan particle β-glucan, particulate β-glucan, PGG-glucan (poly-1,6-β-D-glucopyranosyl-1,3-β-D-glucopyranose) or any mixture thereof.

In some embodiments, the amount of B-glucan in the nutritional composition is between about 3 mg and about 17 mg per 100 kcal. In another embodiment the amount of B- glucan is between about 6 mg and about 17 mg per 100 kcal.

The nutritional composition of the present disclosure, may comprise lactoferrin. Lactoferrins are single chain polypeptides of about 80 kD containing 1-4 glycans, depending on the species. The 3-D structures of lactoferrin of different species are very similar, but not identical. Each lactoferrin comprises two homologous lobes, called the N- and C-lobes, referring to the N-terminal and C-terminal part of the molecule, respectively. Each lobe further consists of two sub-lobes or domains, which form a cleft where the ferric ion (Fe3+) is tightly bound in synergistic cooperation with a (bi)carbonate anion. These domains are called N1, N2, C1 and C2, respectively. The N-terminus of lactoferrin has strong cationic peptide regions that are responsible for a number of important binding characteristics. Lactoferrin has a very high isoelectric point (˜pl 9) and its cationic nature plays a major role in its ability to defend against bacterial, viral, and fungal pathogens. There are several clusters of cationic amino acids residues within the N-terminal region of lactoferrin mediating the biological activities of lactoferrin against a wide range of microorganisms.

Lactoferrin for use in the present disclosure may be, for example, isolated from the milk of a non-human animal or produced by a genetically modified organism. The nutritional compositions described herein can, in some embodiments comprise non-human lactoferrin, non-human lactoferrin produced by a genetically modified organism and/or human lactoferrin produced by a genetically modified organism.

Suitable non-human lactoferrins for use in the present disclosure include, but are not limited to, those having at least 48% homology with the amino acid sequence of human lactoferrin. For instance, bovine lactoferrin (“bLF”) has an amino acid composition which has about 70% sequence homology to that of human lactoferrin. In some embodiments, the non-human lactoferrin has at least 65% homology with human lactoferrin and in some embodiments, at least 75% homology. Non-human lactoferrins acceptable for use in the present disclosure include, without limitation, bLF, porcine lactoferrin, equine lactoferrin, buffalo lactoferrin, goat lactoferrin, murine lactoferrin and camel lactoferrin.

bLF suitable for the present disclosure may be produced by any method known in the art. For example, in U.S. Pat. No. 4,791,193, incorporated by reference herein in its entirety, Okonogi et al. discloses a process for producing bovine lactoferrin in high purity. Generally, the process as disclosed includes three steps. Raw milk material is first contacted with a weakly acidic cationic exchanger to absorb lactoferrin followed by the second step where washing takes place to remove nonabsorbed substances. A desorbing step follows where lactoferrin is removed to produce purified bovine lactoferrin. Other methods may include steps as described in U.S. Pat. Nos. 7,368,141, 5,849,885, 5,919,913 and 5,861,491, the disclosures of which are all incorporated by reference in their entirety.

In certain embodiments, lactoferrin utilized in the present disclosure may be provided by an expanded bed absorption (“EBA”) process for isolating proteins from milk sources. EBA, also sometimes called stabilized fluid bed adsorption, is a process for isolating a milk protein, such as lactoferrin, from a milk source comprises establishing an expanded bed adsorption column comprising a particulate matrix, applying a milk source to the matrix, and eluting the lactoferrin from the matrix with an elution buffer comprising about 0.3 to about 2.0 M sodium chloride. Any mammalian milk source may be used in the present processes, although in particular embodiments, the milk source is a bovine milk source. The milk source comprises, in some embodiments, whole milk, reduced fat milk, skim milk, whey, casein, or mixtures thereof.

In particular embodiments, the target protein is lactoferrin, though other milk proteins, such as lactoperoxidases or lactalbumins, also may be isolated. In some embodiments, the process comprises the steps of establishing an expanded bed adsorption column comprising a particulate matrix, applying a milk source to the matrix, and eluting the lactoferrin from the matrix with about 0.3 to about 2.0M sodium chloride. In other embodiments, the lactoferrin is eluted with about 0.5 to about 1.0 M sodium chloride, while in further embodiments, the lactoferrin is eluted with about 0.7 to about 0.9 M sodium chloride.

The expanded bed adsorption column can be any known in the art, such as those described in U.S. Pat. Nos. 7,812,138, 6,620,326, and 6,977,046, the disclosures of which are hereby incorporated by reference herein. In some embodiments, a milk source is applied to the column in an expanded mode, and the elution is performed in either expanded or packed mode. In particular embodiments, the elution is performed in an expanded mode. For example, the expansion ratio in the expanded mode may be about 1 to about 3, or about 1.3 to about 1.7. EBA technology is further described in international published application nos. WO 92/00799, WO 02/18237, WO 97/17132, which are hereby incorporated by reference in their entireties.

The isoelectric point of lactoferrin is approximately 8.9. Prior EBA methods of isolating lactoferrin use 200 mM sodium hydroxide as an elution buffer. Thus, the pH of the system rises to over 12, and the structure and bioactivity of lactoferrin may be comprised, by irreversible structural changes. It has now been discovered that a sodium chloride solution can be used as an elution buffer in the isolation of lactoferrin from the EBA matrix. In certain embodiments, the sodium chloride has a concentration of about 0.3 M to about 2.0 M. In other embodiments, the lactoferrin elution buffer has a sodium chloride concentration of about 0.3 M to about 1.5 M, or about 0.5 m to about 1.0 M.

The lactoferrin that is used in certain embodiments may be any lactoferrin isolated from whole milk and/or having a low somatic cell count, wherein “low somatic cell count” refers to a somatic cell count less than 200,000 cells/mL. By way of example, suitable lactoferrin is available from Tatua Co-operative Dairy Co. Ltd., in Morrinsville, New Zealand, from FrieslandCampina Domo in Amersfoort, Netherlands or from Fonterra Co-Operative Group Limited in Auckland, New Zealand.

Surprisingly, lactoferrin included herein maintains certain bactericidal activity even if exposed to a low pH (i.e., below about 7, and even as low as about 4.6 or lower) and/or high temperatures (i.e., above about 65° C., and as high as about 120° C.), conditions which would be expected to destroy or severely limit the stability or activity of human lactoferrin. These low pH and/or high temperature conditions can be expected during certain processing regimen for nutritional compositions of the types described herein, such as pasteurization. Therefore, even after processing regimens, lactoferrin has bactericidal activity against undesirable bacterial pathogens found in the human gut.

The nutritional composition may, in some embodiments, comprise lactoferrin in an amount from about 10 mg/100 kcal to about 250 mg/100 kcal. In some embodiments, lactoferrin may be present in an amount of from about 50 mg/100 kcal to about 175 mg/100 kcal. Still in some embodiments, lactoferrin may be present in an amount of from about 100 mg/100 kcal to about 150 mg/100 kcal.

The disclosed nutritional composition described herein, can, in some embodiments also comprise an effective amount of iron. The iron may comprise encapsulated iron forms, such as encapsulated ferrous fumarate or encapsulated ferrous sulfate or less reactive iron forms, such as ferric pyrophosphate or ferric orthophosphate.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In embodiments providing a nutritional composition for a child, the composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In embodiments providing a children's nutritional product, such as a growing-up milk, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to growing-up milks or to other children's nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

The nutritional compositions of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy), alpha lactalbumin and/or mono-and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono-and diglycerides), dextran, carrageenans, and mixtures thereof.

The nutritional compositions of the disclosure may provide minimal, partial or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals. The amount of lipid or fat typically can vary from about 1 to about 25 g/100 kcal. The amount of protein typically can vary from about 1 to about 7 g/100 kcal. The amount of carbohydrate typically can vary from about 6 to about 22 g/100 kcal.

In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

In some embodiments the nutritional composition is an infant formula. Infant formulas are fortified nutritional compositions for an infant. The content of an infant formula is dictated by federal regulations, which define macronutrient, vitamin, mineral, and other ingredient levels in an effort to simulate the nutritional and other properties of human breast milk. Infant formulas are designed to support overall health and development in a pediatric human subject, such as an infant or a child.

In some embodiments, the nutritional composition of the present disclosure is a growing-up milk. Growing-up milks are fortified milk-based beverages intended for children over 1 year of age (typically from 1-3 years of age, from 4-6 years of age or from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of a growing-up milk or other nutritional composition according to the present disclosure can vary from market-to-market, depending on local regulations and dietary intake information of the population of interest. In some embodiments, nutritional compositions according to the disclosure consist of a milk protein source, such as whole or skim milk, plus added sugar and sweeteners to achieve desired sensory properties, and added vitamins and minerals. The fat composition may, in some embodiments, include an enriched lipid fraction derived from milk. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

The disclosed nutritional composition(s) may be provided in any form known in the art, such as a powder, a gel, a suspension, a paste, a solid, a liquid, a liquid concentrate, a reconstituteable powdered milk substitute or a ready-to-use product. The nutritional composition may, in certain embodiments, comprise a nutritional supplement, children's nutritional product, infant formula, human milk fortifier, growing-up milk or any other nutritional composition designed for an infant or a pediatric subject. Nutritional compositions of the present disclosure include, for example, orally-ingestible, health-promoting substances including, for example, foods, beverages, tablets, capsules and powders. Moreover, the nutritional composition of the present disclosure may be standardized to a specific caloric content, it may be provided as a ready-to-use product, or it may be provided in a concentrated form. In some embodiments, the nutritional composition is in powder form with a particle size in the range of 5 μm to 1500 μm, such as (but not limited to) in the range of 10 μm to 300 μm.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

### FORMULATION EXAMPLE

| | Per 100 kCal | |
|---|---|---|
| Nutrient/Lipid | Minimum | Maximum |
| Protein (g) | 1 | 7 |
| Fat (g) | 1 | 10 |
| Carbohydrates (g) | 5 | 25 |
| DHA (mg) | 5 | 100 |
| GOS (g) | 0.1 | 1.0 |
| PDX (g) | 0.1 | 0.5 |
| LGG (CFU) | 1 × 10⁴ | 1.5 × 10¹⁰ |
| Milk oligosaccharides | 0.005 | 1 |
| (e.g. sialyllactose) (g) | | |
| Bacterial metabolites comprising: | 0.05 | 1000 |
| short chain fatty acids (SCFA), bile | | |
| acids, polyphenols, amino acids, | | |
| neurotransmitters and signaling | | |
| factors (mg) | | |
| Vitamin A (IU) | 134 | 921 |
| Vitamin D (IU) | 22 | 126 |
| Vitamin E (IU) | 0.8 | 5.4 |
| Vitamin K (mcg) | 2.9 | 18 |
| Thiamin (mcg) | 63 | 328 |
| Riboflavin (mcg) | 68 | 420 |
| Vitamin B6 (mcg) | 52 | 397 |
| Vitamin B12 (mcg) | 0.2 | 0.9 |
| Niacin (mcg) | 690 | 5881 |
| Folic acid (mcg) | 8 | 66 |
| Pantothenic acid (mcg) | 232 | 1211 |
| Biotin (mcg) | 1.4 | 5.5 |
| Vitamin C (mg) | 4.9 | 24 |
| Choline (mg) | 4.9 | 43 |
| Calcium (mg) | 68 | 297 |
| Phosphorus (mg) | 54 | 210 |
| Magnesium (mg) | 4.9 | 34 |
| Sodium (mg) | 24 | 88 |
| Potassium (mg) | 82 | 346 |
| Chloride (mg) | 53 | 237 |
| Iodine (mcg) | 8.9 | 79 |
| Iron (mg) | 0.7 | 2.8 |
| Zinc (mg) | 0.7 | 2.4 |
| Manganese (mcg) | 7.2 | 41 |
| Copper (mcg) | 16 | 331 |

Formulation examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with all the examples disclosed herein, be considered to be exemplary only, with the scope and spirit of the disclosure being indicated by the claims, which follow the examples.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

What is claimed is:

1. A nutritional composition comprising:
a. about 1 g/100 kcal to about 7 g/100 kcal of a protein or protein equivalent source;
b. about 1 g/100 kcal to about 10 g/100 kcal of a fat or lipid source;
c. about 5 g/100 kcal to about 25 g/100 kcal of a carbohydrate;
d. about 0.05 mg/100 kcal to about 1 g/100 kcal of a plurality of bacterial metabolites produced by microbiota fermentation, wherein the plurality of bacterial metabolites comprises:
(i) at least one short chain fatty acid (SCFA);
(ii) at least one bile acid;
(iii) at least one polyphenol;
(iv) at least one amino acid; and
(v) at least one neurotransmitter;
e. a prebiotic composition; and
f. a probiotic composition.

2. The nutritional composition of claim 1, wherein the plurality of bacterial metabolites further comprises at least one additional component selected from the group consisting of indoleacetate, 5-amino valerate, phenyllactate, or combinations thereof, and wherein the at least one additional component is present at a level of about 0.5 mg/100 kcal to about 500 mg/100 kcal.

3. The nutritional composition of claim 1, wherein the plurality of bacterial metabolites further comprises at least one additional component selected from the group consisting of homovanillate, N,N-dimethylglycine, hippurate, benzoate, or combinations thereof, and wherein the at least one additional component is present at a level of about 0.5 mg/100 kcal to about 500 mg/100 kcal.

4. The nutritional composition of claim 1, wherein the probiotic composition comprises Lactobacillus rhamnosus GG in an amount of about 1×10⁴ cfu/100 kcal to about 1.5×10¹⁰ cfu/100 kcal.

5. The nutritional composition of claim 1, further comprising about 0.1 g/100 kcal to about 1 g/100 kcal of the prebiotic composition, and wherein the prebiotic composition comprises polydextrose and galacto-oligosaccharide.

6. The nutritional composition of claim 1, further comprising about 5 mg/100 kcal to about 100 mg/100 kcal of a long chain polyunsaturated fatty acid.

7. The nutritional composition of claim 1, wherein the protein source comprises lactoferrin at a level of about 10 mg/100 kcal to about 200 mg/100 kcal.

8. The nutritional composition of claim 1, wherein the nutritional composition is an infant formula or a growing up milk.

9. The nutritional composition of claim 1, wherein the at least one SCFA is selected from the group consisting of acetate, butyrate, propionate, and combinations thereof.

10. The nutritional composition of claim 1, wherein at least one of:
the at least one bile acid is selected from the group consisting of 6-beta-hydroxylithocholate, hyocholate, glycohyocholate, hyodeoxycholate, taurohyodeoxycholic acid, glycohyodeoxycholic acid, and combinations thereof;
the at least one polyphenol is selected from the group consisting of equol, 3,4-Dihydroxyphenyl acetic acid (DOPAC), 5-(3′,4′-Dihydroxyphenyl)-γ-valerolactone; and/or
the at least one neurotransmitter is selected from the group consisting of gamma-aminobutyric acid (GABA), noradrenaline, serotonin, dopamine, acetylcholine, and combinations thereof.

11. A method, comprising:
identifying a pediatric subject having colic; and
administering to the pediatric subject a nutritional composition which comprises:
a. about 1 g/100 kcal to about 7 g/100 kcal of a protein or protein equivalent source;
b. about 1 g/100 kcal to about 10 g/100 kcal of a fat or lipid source;
c. about 5 g/100 kcal to about 25 g/100 kcal of a carbohydrate;
d. a plurality of bacterial metabolites produced by microbiota fermentation, wherein each of the plurality of bacterial metabolites is present at a level of about 0.05 mg/100 kcal to about 1 g/100 kcal, and wherein the plurality of bacterial metabolites comprises:
(i) at least one short chain fatty acid (SCFA);
(ii) at least one bile acid;
(iii) at least one polyphenol;
(iv) at least one amino acid; and
(v) at least one neurotransmitter;
e. a prebiotic composition; and
f. a probiotic composition.

12. The method of claim 11, wherein the plurality of bacterial metabolites in the nutritional composition further comprises at least one additional component selected from the group consisting of indoleacetate, 5-amino valerate, phenyllactate, or combinations thereof, and wherein the at least one additional component is present at a level of about 0.5 mg/100 kcal to about 500 mg/100 kcal.

13. The method of claim 11, wherein the plurality of bacterial metabolites in the nutritional composition further comprises at least one additional component selected from the group consisting of homovanillate, N,N-dimethylglycine, hippurate, benzoate, or combinations thereof, and wherein the at least one additional component is present at a level of about 0.5 mg/100 kcal to about 500 mg/100 kcal.

14. The method of claim 11, wherein the probiotic composition of the nutritional composition comprises Lactobacillus rhamnosus GG in an amount of from about 1×10⁴ cfu/100 kcal to about 1.5×10¹⁰ cfu/100 kcal.

15. The method of claim 11, wherein the nutritional composition comprises about 0.1 g/100 kcal to about 1 g/100 kcal of the prebiotic composition, and wherein the prebiotic composition comprises polydextrose and galactooligosaccharide.

16. The method of claim 11, wherein the nutritional composition further comprises about 5 mg/100 kcal to about 100 mg/100 kcal of a long chain polyunsaturated fatty acid.

17. The method of claim 11, wherein the protein source in the nutritional composition comprises lactoferrin at a level of about 10 mg/100 kcal to about 200 mg/100 kcal.

18. The method of claim 11, wherein the nutritional composition is an infant formula or a growing up milk.

19. The method of claim 11, wherein the at least one SCFA is selected from the group consisting of acetate, butyrate, propionate, and combinations thereof.

20. The method of claim 11, wherein at least one of:
the at least one bile acid is selected from the group consisting of 6-beta-hydroxylithocholate, hyocholate, glycohyocholate, hyodeoxycholate, taurohyodeoxycholic acid, glycohyodeoxycholic acid, and combinations thereof;
the at least one polyphenol is selected from the group consisting of equol, 3,4-Dihydroxyphenyl acetic acid (DOPAC), 5-(3′,4′-Dihydroxyphenyl)-γ-valerolactone; and/or
the at least one neurotransmitter is selected from the group consisting of gamma-aminobutyric acid (GABA), noradrenaline, serotonin, dopamine, acetylcholine, and combinations thereof.
